(19) United States
(12) Patent Application Publication
(10) Pub. No.: US 2018/0354314 A1
(43) Pub. Date: Dec. 13, 2018

(54) Pneumatic Tire

(71) Applicants: The Yokohama Rubber Co., LTD., Minato-ku, Tokyo (JP); Kumho Tire Co., Inc., Gwangsan-gu, Gwangju (KR)

(72) Inventors: Hiroshi Hata, Hiratsuka-shi, Kanagawa (JP); Jun Matsuda, Hiratsuka-shi, Kanagawa (JP); Kee Woon Kim, Gwangsan-gu, Gwangju (KR); Chang Jung Park, Gwangsan-gu, Gwangju (KR)

(21) Appl. No.: 15/778,621

(22) PCT Filed: Nov. 25, 2015
(86) PCT No.: PCT/JP2015/082994

§ 371 Date: May 23, 2018

(51) Int. Cl. B60C 11/13; B60C 11/01; B60C 11/12; B60C 11/03

(52) U.S. Cl. CPC B60C 11/1315; B60C 11/01; B60C 11/1259; B60C 2011/0372; B60C 11/0306; B60C 2011/0346; B60C 2011/129; B60C 11/1218

(57) ABSTRACT

A pneumatic tire, includes: a lug groove outermost in a lateral direction in a tread portion, the lug groove opening outward in the lateral direction; and a projection portion outward of an opening portion of the lug groove in the lateral direction, the projection portion extending outward in a radial direction past a groove bottom of the lug groove at maximum groove depth and including an end inward of a road contact surface of the tread portion in the radial direction, when the pneumatic tire is inflated to a regular internal pressure and loaded with 70% of a regular load; the projection portion including a body projecting from a tire surface, and an end projection extending from the end of the body with a step portion as an interface, and the end projection having a thinner meridian cross-sectional width than a meridian cross-sectional width of the end of the body.

### TECHNICAL FIELD

The present technology relates to a pneumatic tire that reduces external noise.

### BACKGROUND ART

In the related art, pneumatic tires designed to reduce vehicle external noise are known. For example, the pneumatic tire described in Japanese Patent Publication No. 2012-096776 includes a lug groove that opens outward in a tire lateral direction on an outermost side of a tread portion in the tire lateral direction, and a projection portion disposed outward of the opening portion of the lug groove in the tire lateral direction. According to this pneumatic tire, by the projection portion being located outward of the opening portion of the lug groove in the tire lateral direction, when a vehicle on which the pneumatic tire is mounted travels, the sound produced by air column resonance is prevented from being released outward from the lug groove in the tire lateral direction. As a result, vehicle external noise can be reduced.

In another example, the pneumatic tire described in Japanese Patent Publication No. 2012-006483 includes a projection portion on an outer surface of a buttress portion, the projection portion projecting outward in a tire radial direction and continuously extending in a tire circumferential direction.

As described above, Japanese Patent Publication Nos. 2012-096776 and 2012-006483 describe a projection portion blocking sound from being released outward in the tire lateral direction. However, when the projection portion comes into contact with the road surface under heavy load, the projection portion becomes a source of vibration generating noise. This may reduce the vehicle exterior noise reduction effect or stop a vehicle exterior noise reduction effect from being obtained.

### SUMMARY

The present technology provides a pneumatic tire that can ensure a vehicle external noise reduction effect.

A pneumatic tire according to an embodiment of the present technology includes:

a lug groove disposed outermost in a tire lateral direction in a tread portion, the lug groove opening outward in the tire lateral direction; and

a projection portion disposed outward of an opening portion of the lug groove in the tire lateral direction, the projection portion extending outward in a tire radial direction past a groove bottom of the lug groove at maximum groove depth in a meridian cross-section and including an end disposed inward of a road contact surface of the tread portion in the tire radial direction, when the pneumatic tire is mounted on a regular rim, inflated to a regular internal pressure, and loaded with 70% of a regular load;

the projection portion including a projection portion body projecting from a tire surface, and an end projection extending from the end of the projection portion body with a step portion as an interface, and the end projection having a thinner meridian cross-sectional width than a meridian cross-sectional width of the end of the projection portion body.

According to the pneumatic tire, when the end of the projection portion comes into contact with the road surface, the end projection comes into contact with the road surface. The end projection has a narrower meridian cross-sectional width than that of the end of the projection portion body. This reduces rigidity resistance, and makes the end projection less susceptible to becoming a vibration source that causes noise. As a result, vehicle exterior noise reduction effect can be ensured.

In the pneumatic tire according to an embodiment of the present technology, the end projection, in a 3 mm-range in a projection direction of the projection portion body, has a maximum meridian cross-sectional width 70% or less of a minimum meridian cross-sectional width of the projection portion body.

According to the pneumatic tire, by the maximum meridian cross-sectional width of the end projection being 70% or less of the minimum meridian cross-sectional width of the projection portion body, when contact is made with the road surface, the end projection is less susceptible to becoming a vibration source and a small rigidity resistance is formed. As a result, the effect of ensuring the vehicle exterior noise reduction effect can be significantly obtained.

In the pneumatic tire according to an embodiment of the present technology, the end projection has an extension height from the projection portion body ranging from 0.5 mm to 20 mm.

When the extension height of the end projection is less than 0.5 mm, the effect of reducing rigidity resistance is small and the end projection is susceptible to becoming a vibration source. When the extension height of the end projection is greater than 20 mm, the effect of reducing rigidity resistance is not greatly changed. Thus, according to the pneumatic tire, the effect of ensuring a vehicle exterior noise reduction effect can be significantly obtained.

In the pneumatic tire according to an embodiment of the present technology, the end projection has a maximum meridian cross-sectional width from 1% to 50% of a minimum meridian cross-sectional width of the projection portion body.

When the maximum meridian cross-sectional width of the end projection is less than 1% of the minimum meridian cross-sectional width of the projection portion body, the end projection is essentially absent, and an effect from the end projection may not be obtained. When the maximum meridian cross-sectional width of the end projection is greater than 50% of the minimum meridian cross-sectional width of the projection portion body, the effect of reducing rigidity resistance is small and the end projection is susceptible to becoming a vibration source. Thus, according to the pneumatic tire, the effect of ensuring a vehicle exterior noise reduction effect can be significantly obtained.

In the pneumatic tire according to an embodiment of the present technology, the end projection is disposed intermittently in a tire circumferential direction.

According to the pneumatic tire, by disposing the end projection intermittently in the tire circumferential direction, the effect of reducing rigidity resistance can be significantly obtained, and the effect of ensuring the vehicle exterior noise reduction effect can be significantly obtained.

In the pneumatic tire according to an embodiment of the present technology, the projection portion has a distance in the tire radial direction from the road contact surface of the tread portion to an end of the end projection of 0.5 mm or greater, when the pneumatic tire is mounted on a regular rim, inflated to a regular internal pressure, and loaded with 70% of a regular load.

In a case where the distance in the tire radial direction between the road contact surface of the tread portion and the end of the end projection is less than 0.5 mm, when the pneumatic tire deforms when the vehicle travels, the frequency of the projection portion coming into contact with the road surface and the like is likely to increase, increasing instances of the projection portion deforming. Thus, according to the pneumatic tire, by the distance in the tire radial direction between the road contact surface of the tread portion and the end of the end projection being 0.5 mm to greater, the instances of the projection portion deforming are reduced. This allows a vehicle exterior noise reduction effect to be ensured.

In a pneumatic tire according to an embodiment of the present technology, the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

When the angle formed by the center straight line and the tire radial direction line is greater than 15° inward in the tire lateral direction, the projection portion is susceptible to coming into contact with the tire itself, which may cause wear and chipping in the portion where contact occurs. When the angle formed by the center straight line and the tire radial direction line is greater than 45° outward in the tire lateral direction, the projection portion is disposed away from the lug groove, and a noise shielding effect is difficult to obtain. Thus, according to the pneumatic tire, by the angle formed by the center straight line and the tire radial direction line ranging from 15° inward in the tire lateral direction to 45° outward in the tire lateral direction (from −15° to +45°, where inward in the tire lateral direction is minus and outward in the tire lateral direction is plus), a noise shielding effect from the projection portion can be significantly obtained.

In a pneumatic tire according to an embodiment of the present technology, a vehicle inner/outer side orientation when the pneumatic tire is mounted on a vehicle is designated, and the projection portion is at least formed on a vehicle outer side.

According to the pneumatic tire, vehicle external noise is released on the vehicle outer side. Thus, by forming the projection portion on at least the vehicle outer side, noise shielding can be effectively provided, and vehicle external noise can be reduced. A pneumatic tire according to an embodiment of the present technology can ensure a vehicle exterior noise reduction effect.

### BRIEF DESCRIPTION OF DRAWINGS

FIG. 1 is a meridian cross-sectional view of a pneumatic tire according to an embodiment of the present technology.

FIG. 2 is a meridian cross-sectional view of a pneumatic tire according to an embodiment of the present technology.

FIG. 3 is an enlarged view of a main portion of the pneumatic tire illustrated in FIGS. 1 and 2.

FIG. 4 is an enlarged view of a main portion of the pneumatic tire illustrated in FIGS. 1 and 2.

FIG. 5 is a side view of a portion of a projection portion as viewed from the tire lateral direction.

FIG. 6 is a plan view of a portion of the projection portion illustrated in FIG. 5.

FIG. 7 is a plan view of a portion of the projection portion illustrated in FIG. 5.

FIG. 8 is a plan view of a portion of the projection portion illustrated in FIG. 5.

FIG. 9 is a side view of a portion of a projection portion as viewed from the tire lateral direction.

FIG. 10 is a plan view of a portion of the projection portion illustrated in FIG. 9.

FIG. 11 is a plan view of a portion of the projection portion illustrated in FIG. 9.

FIG. 12 is a plan view of a portion of the projection portion illustrated in FIG. 9.

FIG. 13 is a plan view of a portion of the projection portion illustrated in FIG. 9.

FIG. 14 is an enlarged cross-sectional view of a main portion of another example of a pneumatic tire according to an embodiment of the present technology.

FIG. 15 is a partial perspective view of another example of the pneumatic tire illustrated in FIG. 14.

FIG. 16 is a table showing the results of performance tests of pneumatic tires according to examples of the present technology.

FIG. 17 is a table showing the results of performance tests of pneumatic tires according to examples of the present technology.

FIG. 18 is a table showing the results of performance tests of pneumatic tires according to examples of the present technology.

### DETAILED DESCRIPTION

Embodiments of the present technology are described in detail below with reference to the drawings. However, the present technology is not limited by the embodiments. Constituents of the embodiments include elements that can be easily replaced by those skilled in the art and elements substantially the same as the constituents of the embodiments. Furthermore, the modified examples described in the embodiments can be combined as desired within the scope apparent to those skilled in the art.

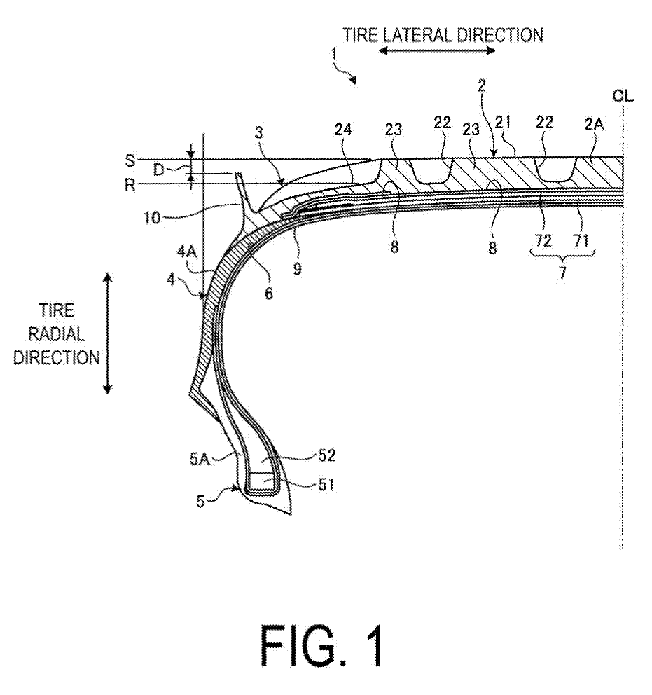

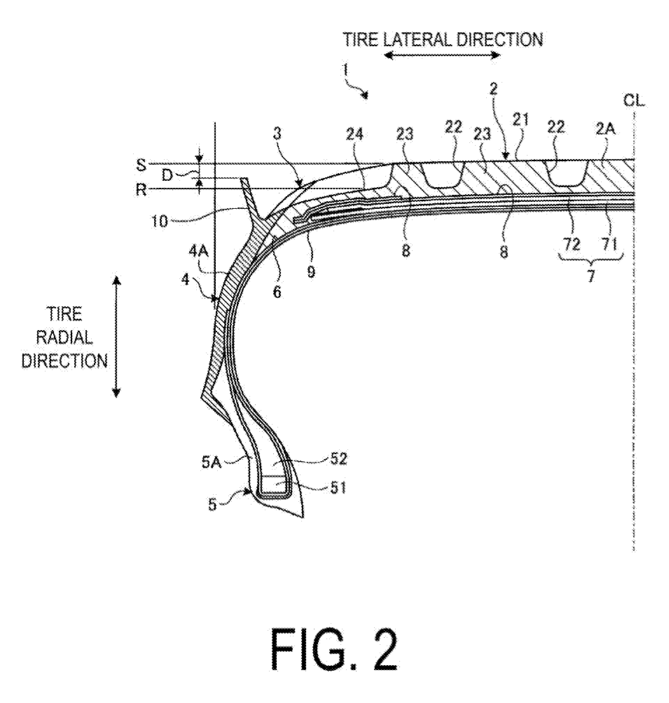

FIGS. 1 and 2 are meridian cross-sectional views of a pneumatic tire according to the present embodiment.

Herein, “tire radial direction” refers to the direction orthogonal to the rotation axis (not illustrated) of a pneumatic tire 1. “Inward in the tire radial direction” refers to the direction toward the rotation axis in the tire radial direction. “Outward in the tire radial direction” refers to the direction away from the rotation axis in the tire radial direction. “Tire circumferential direction” refers to the circumferential direction with the rotation axis as the center axis. Additionally, “tire lateral direction” refers to the direction parallel with the rotation axis. “Inward in the tire lateral direction” refers to the direction toward a tire equatorial plane CL (tire equator line) in the tire lateral direction. “Outward in the tire lateral direction” refers to the direction away from the tire equatorial plane CL in the tire lateral direction. “Tire equatorial plane CL” refers to the plane orthogonal to the rotation axis of the pneumatic tire 1 that passes through the center of the tire width of the pneumatic tire 1. “Tire width” is the width in the tire lateral direction between components located outward in the tire lateral direction, or in other words, the distance between the components that are the most distant from the tire equatorial plane CL in the tire lateral direction. “Tire equator line” refers to the line along the tire circumferential direction of the pneumatic tire 1 that lies on the tire equatorial plane CL. In the present embodiment, the tire equator line and the tire equatorial plane are denoted by the same reference sign CL. In addition, the pneumatic tire 1 described below has a configuration which is essentially symmetrical about the tire equatorial plane CL. Thus, for the sake of description, the pneumatic tire 1 is illustrated in a meridian cross-sectional view (FIGS. 1 and 2) and described in reference to the configuration on only one side (the left side in FIGS. 1 and 2) of the tire equatorial plane CL. A description of the other side (right side in FIGS. 1 and 2) is omitted.

As illustrated in FIGS. 1 and 2, the pneumatic tire 1 of the present embodiment includes a tread portion 2, shoulder portions 3 on opposite sides of the tread portion 2, and sidewall portions 4 and bead portions 5 continuing in that order from the shoulder portions 3. The pneumatic tire 1 also includes a carcass layer 6, a belt layer 7, a belt reinforcing layer 8, and an innerliner layer 9.

The tread portion 2 is made of tread rubber 2A, is exposed on the outermost side of the pneumatic tire 1 in the tire radial direction, and the surface thereof constitutes the contour of the pneumatic tire 1. A tread surface 21 is formed on the outer circumferential surface of the tread portion 2, in other words, on the road contact surface that comes into contact with the road surface when running. The tread surface 21 is provided with a plurality (four in the present embodiment) of main grooves 22 that are straight main grooves extending in the tire circumferential direction parallel with the tire equator line CL. Moreover, a plurality of rib-like land portions 23 that extend in the tire circumferential direction are formed in the tread surface 21 by the plurality of main grooves 22. Note that the main grooves 22 may extend in the tire circumferential direction in a bending or curving manner. Additionally, lug grooves 24 that extend in a direction that intersects the main grooves 22 are provided in the land portions 23 of the tread surface 21. In the present embodiment, the lug grooves 24 show in the outermost land portions 23 in the tire lateral direction. The lug grooves 24 may meet the main grooves 22. Alternatively, the lug grooves 24 may have at least one end that does not meet the main grooves 22 and terminates within a land portion 23. In an embodiment in which both ends of the lug grooves 24 meet the main grooves 22, the land portions 23 are formed into a plurality of block-like land portions divided in the tire circumferential direction. Note that the lug grooves 24 may extend inclined with respect to the tire circumferential direction in a bending or curving manner.

The shoulder portions 3 are portions of the tread portion 2 located outward in the tire lateral direction on both sides. In other words, the shoulder portions 3 are made of the tread rubber 2A. Additionally, the sidewall portions 4 are exposed on the outermost sides of the pneumatic tire 1 in the tire lateral direction. The sidewall portions 4 are each made of a side rubber 4A. As illustrated in FIG. 1, an outer end portion of the side rubber 4A in the tire radial direction is disposed inward of an end portion of the tread rubber 2A in the tire radial direction. An inner end portion of the side rubber 4A in the tire radial direction is disposed outward of an end portion of a rim cushion rubber 5A described below in the tire lateral direction. Additionally, as illustrated in FIG. 2, the outer end portion of the side rubber 4A in the tire radial direction may be disposed outward of the end portion of the tread rubber 2A in the tire radial direction. The bead portions 5 each include a bead core 51 and a bead filler 52. The bead core 51 is formed by winding a bead wire, which is a steel wire, into an annular shape. The bead filler 52 is a rubber material that is disposed in the space formed by an end of the carcass layer 6 in the tire lateral direction folded back at the position of the bead core 51. The bead portions 5 each include an outwardly exposed rim cushion rubber 5A that comes into contact with the rim (not illustrated). The rim cushion rubber 5A extends from the tire inner side of the bead portion 5 around the lower end portion thereof to a position (sidewall portion 4) covering the bead filler 52 on the tire outer side.

The end portions of the carcass layer 6 in the tire lateral direction are folded back around the pair of bead cores 51 from inward to outward in the tire lateral direction, and the carcass layer 6 is stretched in a toroidal shape in the tire circumferential direction to form the framework of the tire. Note that the carcass layer 6 has a configuration that is mainly continuous in a radial direction, but may include a divided portion on the inner side of the tread portion 2 in the tire radial direction. The carcass layer 6 is constituted by a plurality of coating-rubber-covered carcass cords (not illustrated) disposed in alignment at an angle with respect to the tire circumferential direction that conforms with the tire meridian direction. The carcass layer 6 is provided with at least one layer.

The belt layer 7 has a multilayer structure in which at least two belts 71, 72 are layered. In the tread portion 2, the belt layer 7 is disposed outward of the carcass layer 6 in the tire radial direction, i.e. on the outer circumference thereof, and covers the carcass layer 6 in the tire circumferential direction. The belts 71 and 72 each include a plurality of coating-rubber-covered cords (not illustrated) disposed in alignment at a predetermined angle with respect to the tire circumferential direction (for example, from 20 degrees to 30 degrees). Moreover, the belts 71 and 72 overlap each other and are disposed so that the direction of the cords of the respective belts intersect each other.

The belt reinforcing layer 8 may be provided for support as necessary. The belt reinforcing layer 8 is disposed outward of the belt layer 7 in the tire radial direction, i.e. on the outer circumference thereof, and covers the belt layer 7 in the tire circumferential direction. The belt reinforcing layer 8 includes a plurality of coating-rubber-covered cords (not illustrated) disposed in alignment in the tire lateral direction substantially parallel (±5 degrees) with the tire circumferential direction. The belt reinforcing layer 8 illustrated in FIGS. 1 and 2 is disposed so as to cover the entire belt layer 7 and disposed in a layered manner so as to cover end portions of the belt layer 7 in the tire lateral direction. The configuration of the belt reinforcing layer 8 is not limited to that described above. While not illustrated in the drawings, a configuration may be used in which, for example, two layers are disposed so as to cover all of the belt layer 7 or to cover only the end portions of the belt layer 7 in the tire lateral direction. Additionally, while not illustrated in the drawings, a configuration of the belt reinforcing layer 8 may be used in which, for example, one layer is disposed so as to cover all of the belt layer 7 or to cover only the end portions of the belt layer 7 in the tire lateral direction. In other words, the belt reinforcing layer 8 overlaps with at least the end portions of the belt layer 7 in the tire lateral direction. Additionally, the belt reinforcing layer 8 is constituted of a band-like strip material (having, for example, a width of 10 mm) wound in the tire circumferential direction.

The innerliner layer 9 is the tire inner surface, i.e. the inner circumferential surface of the carcass layer 6, and reaches the lower portion of the bead cores 51 of the pair of bead portions 5 at both end portions in the tire lateral direction and extends in the tire circumferential direction in a toroidal shape. The innerliner layer 9 prevents air molecules from escaping from the tire.

The pneumatic tire 1 described above is provided with a projection portion 10 on the shoulder portion 3. The projection portion 10 is provided continuously in the tire circumferential direction and is disposed outward in the tire lateral direction of the opening portion of the outermost lug groove 24 in the tire lateral direction provided on the tread portion 2. The projection portion 10 is formed projecting outward in the tire radial direction. Additionally, the projection portion 10, in a meridian cross-section, extends outward in the tire radial direction of a groove bottom R with the maximum groove depth of the outermost lug groove 24 in the tire lateral direction, and an end (an end of an end projection 10B described below) of the projection portion 10 is disposed inward in the tire radial direction of the road contact surface S of the tread portion 2, when the pneumatic tire 1 is mounted on a regular rim, inflated to the regular internal pressure, and loaded with 70% of the regular load. Note that a portion of the lug groove 24 may run into the inner surface in the tire lateral direction of the projection portion 10.

Here, “regular rim” refers to a “standard rim” defined by the Japan Automobile Tyre Manufacturers Association Inc. (JATMA), a “Design rim” defined by the Tire and Rim Association, Inc. (TRA), or a “Measuring rim” defined by the European Tyre and Rim Technical Organisation (ETRTO). “Regular internal pressure” refers to “maximum air pressure” defined by JATMA, a maximum value given in “TIRE LOAD LIMITS AT VARIOUS COLD INFLATION PRESSURES” defined by TRA, or “INFLATION PRESSURES” defined by ETRTO. “Regular load” refers a “maximum load capacity” defined by JATMA, the maximum value given in “TIRE LOAD LIMITS AT VARIOUS COLD INFLATION PRESSURES” defined by TRA, and a “LOAD CAPACITY” defined by ETRTO.

The road contact surface S is the surface where the tread surface 21 of the pneumatic tire 1 comes into contact with the road surface, when the pneumatic tire 1 is mounted on a regular rim, inflated to the regular internal pressure, and loaded with 70% of the regular load.

As illustrated in FIGS. 1 and 2, the projection portion 10 is integrally formed with the tread rubber 2A of the tread portion 2 or the side rubber 4A of the sidewall portion 4 described above. In the pneumatic tire 1 illustrated in FIG. 1, an outer end portion of the side rubber 4A in the tire radial direction is disposed inward of an end portion of the tread rubber 2A in the tire radial direction, and the projection portion 10 is disposed together with the outer end portion of the tread rubber 2A in the tire lateral direction. In the pneumatic tire 1 illustrated in FIG. 2, an outer end portion of the side rubber 4A in the tire radial direction is disposed outward of an end portion of the tread rubber 2A in the tire radial direction, and the projection portion 10 is disposed together with the outer end portion of the side rubber 4A in the tire radial direction.

According to this pneumatic tire 1, by the projection portion 10 being located outward of the opening portion of the lug groove 24 in the tire lateral direction, when a vehicle on which the pneumatic tire 1 is mounted travels, the sound produced by air column resonance is shielded and prevented from being released outward from the lug groove 24 in the tire lateral direction. As a result, vehicle external noise can be reduced.

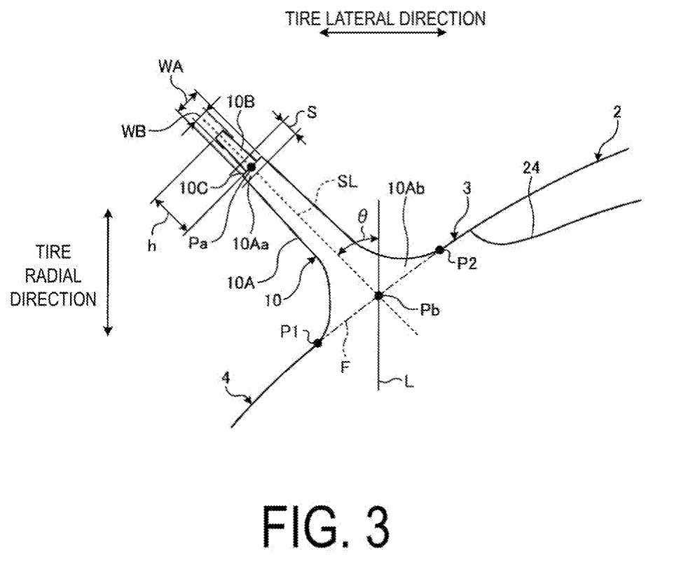

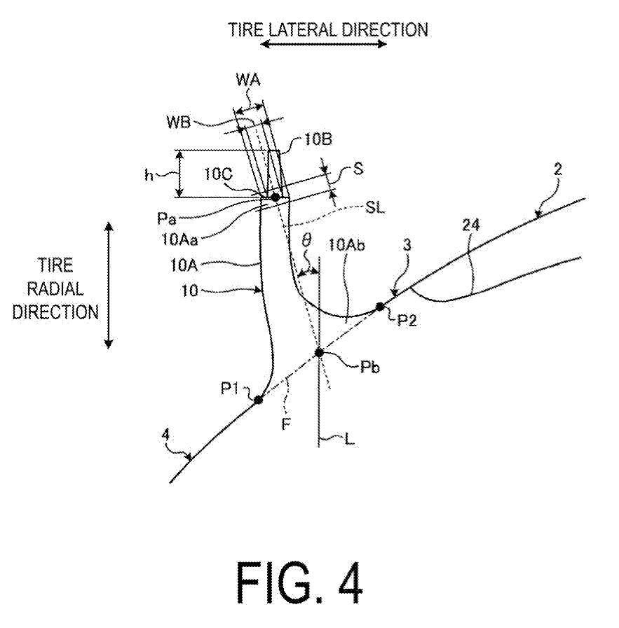

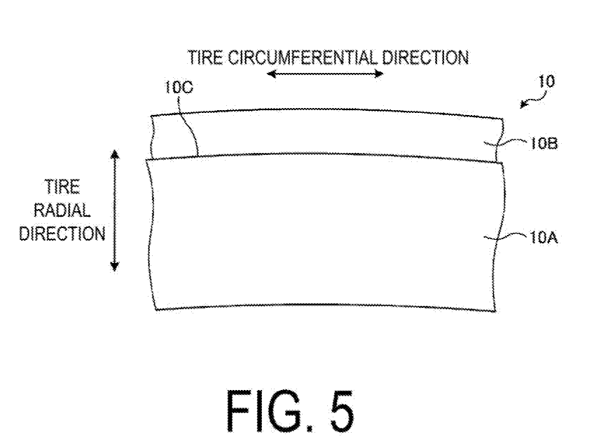

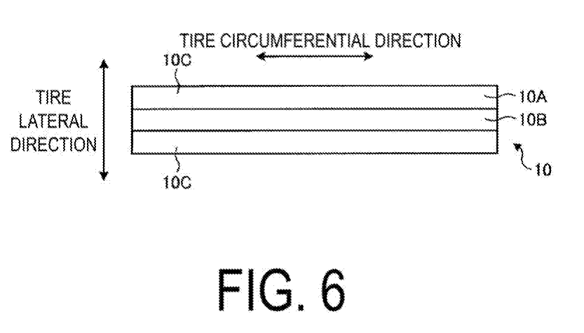

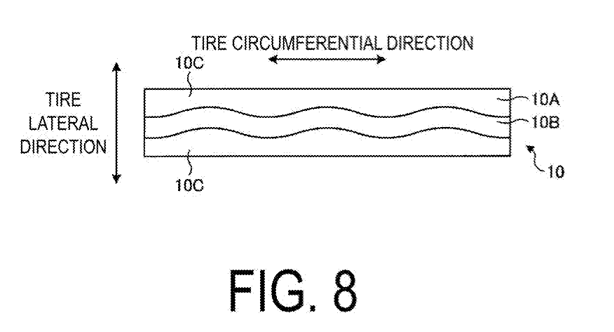

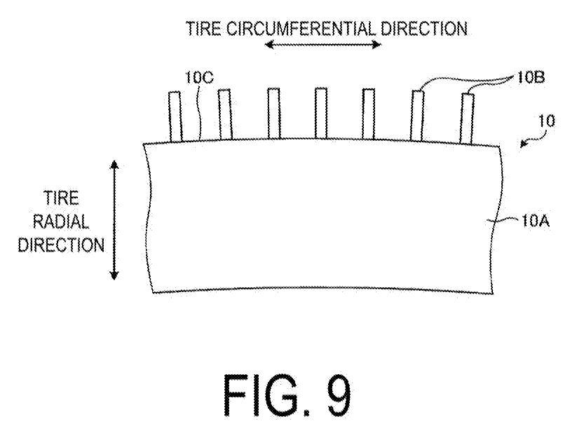

FIGS. 3 and 4 are enlarged views of a main portion of the pneumatic tire illustrated in FIGS. 1 and 2, with the projection portion 10 enlarged. FIG. 5 is a side view of a portion of a projection portion as viewed from the tire lateral direction. FIGS. 6 to 8 are plan views of a portion of the projection portion illustrated in FIG. 5. FIG. 9 is a side view of a portion of a projection portion as viewed from the tire lateral direction. FIGS. 8 to 13 are plan views of a portion of the projection portion illustrated in FIG. 9.

As illustrated in FIGS. 3 and 4, in the pneumatic tire 1 of the present embodiment, the projection portion 10 includes a projection portion body 10A and the end projection 10B.

The projection portion body 10A is the base portion that composes the projection portion 10 and projects from the tire surface. The end projection 10B extends from an end 10Aa of the projection portion body 10A with a step portion 10C as an interface. The end projection 10B is shaped with a thinner meridian cross-sectional width than that of the end 10Aa of the projection portion body 10A. The end projection 10B is disposed along the tire circumferential direction. The step portion 10C is the portion where the meridian cross-section width changes, and is the boundary between the projection portion body 10A and the end projection 10B.

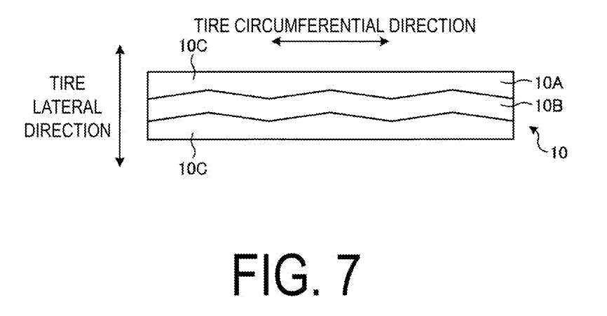

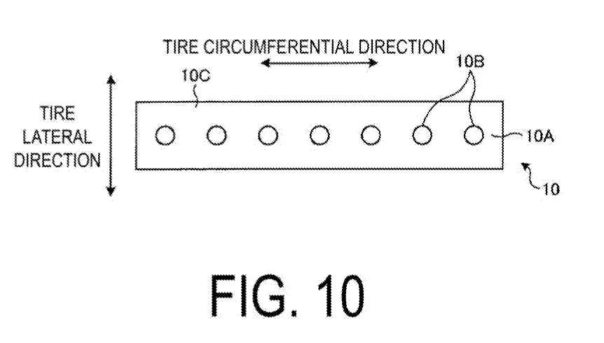

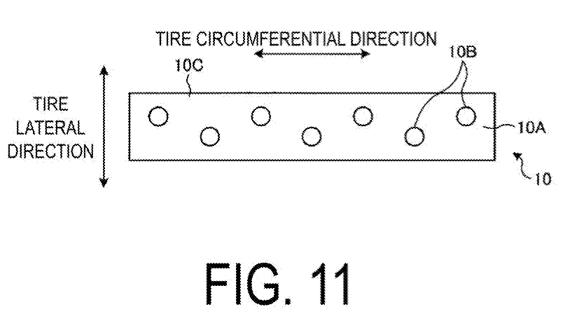

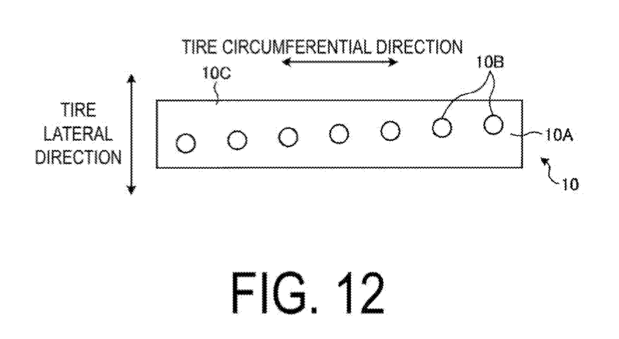

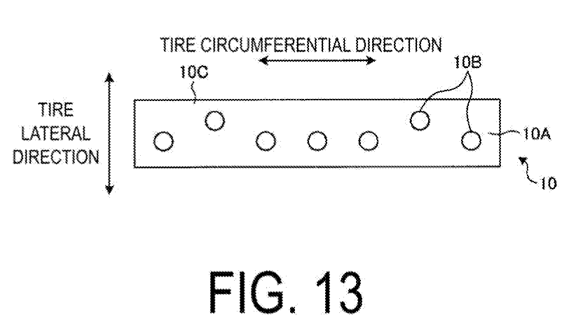

As illustrated in FIG. 5 and FIGS. 6 to 8, the end projection 10B may be provided continuously in the tire circumferential direction, or as illustrated in FIG. 9 and FIGS. 10 to 13, may be provided intermittently in the tire circumferential direction. In an embodiment in which the end projection 10B is provided continuously in the tire circumferential direction, as illustrated in FIG. 6, the end projection 10B may have a linear shape along the tire circumferential direction; as illustrated in FIG. 7, the end projection 10B may have a zigzag shape bent in the tire lateral direction; and as illustrated in FIG. 8, the end projection 10B may have a curvilinear shape that curves in the tire lateral direction. In an embodiment in which the end projection 10B is provided intermittently in the tire circumferential direction, as illustrated in FIG. 10, the end projections 10B may be linearly aligned along the tire circumferential direction; as illustrated in FIG. 11, the end projections 10B may be provided offset from one another in the tire lateral direction; as illustrated in FIG. 12, the end projections 10B may be provided at an incline in the tire lateral direction; and as illustrated in FIG. 13, the end projections 10B may be provided with end projections 10B offset in the tire lateral direction at intervals.

According to the pneumatic tire 1, when the end of the projection portion 10 comes into contact with the road surface, the end projection 10B comes into contact with the road surface. The end projection 10B has a narrower meridian cross-sectional width than that of the end 10Aa of the projection portion body 10A. This reduces rigidity resistance, and makes the end projection 10B less susceptible to becoming a vibration source that causes noise. As a result, vehicle exterior noise reduction effect can be ensured.

In the pneumatic tire 1 of the present embodiment, in the 3 mm-range in the projection direction of the end projection 10B including the step portion 10C, the maximum meridian cross-sectional width WB is 70% or less of the minimum meridian cross-sectional width WA of the projection portion body 10A.

As illustrated in FIGS. 3 and 4, “projection direction” is the extension direction, in a meridian cross-section, of a center straight line SL that joins a center point Pa of the thickness of the end 10Aa of the projection portion body 10A and a center point Pb between points P1, P2 that meet at the thickness (an imaginary profile F of the shoulder portion 3 between the tread portion 2 and the sidewall portion 4) of a base end 10Ab. “Meridian cross-sectional width” is the dimension, in the meridian cross-section, across the surface where a line orthogonal to the center straight line SL meets the surface of the projection portion body 10A or the end projection 10B.

According to the pneumatic tire 1, by the maximum meridian cross-sectional width WB of the end projection 10B being 70% or less of the minimum meridian cross-sectional width WA of the projection portion body 10A, when contact is made with the road surface, the end projection 10B is less susceptible to becoming a vibration source and a small rigidity resistance is formed. As a result, the effect of ensuring the vehicle exterior noise reduction effect can be significantly obtained.

According to the pneumatic tire 1 of the present embodiment, an extension height h of the end projection 10B from the projection portion body 10A preferably ranges from 0.5 mm to 20 mm.

The extension height h of the end projection 10B is a dimension from the end 10Aa (step portion 10C) of the projection portion body 10A to the portion at maximum extension.

When the extension height h of the end projection 10B is less than 0.5 mm, the effect of reducing rigidity resistance is small and the end projection 10B is susceptible to becoming a vibration source. When the extension height h of the end projection 10B is greater than 20 mm, the effect of reducing rigidity resistance is not greatly changed. Thus, according to the pneumatic tire 1, the effect of ensuring a vehicle exterior noise reduction effect can be significantly obtained.

In the pneumatic tire 1 of the present embodiment, the end projection 10B is formed such that the maximum meridian cross-sectional width is preferably from 1% to 50% of the minimum meridian cross-sectional width of the projection portion body 10A.

Note that in the FIGS. 3 and 4, the maximum meridian cross-sectional width of the end projection 10B corresponds to the portion denoted with the reference sign WB, and the minimum meridian cross-sectional width of the projection portion body 10A corresponds to the portion denoted with the reference sign WA.

When the maximum meridian cross-sectional width of the end projection 10B is less than 1% of the minimum meridian cross-sectional width of the projection portion body 10A, the end projection 10B is essentially absent, and an effect from the end projection 10B may not be obtained. When the maximum meridian cross-sectional width of the end projection 10B is greater than 50% of the minimum meridian cross-sectional width of the projection portion body 10A, the effect of reducing rigidity resistance is small and the end projection 10B is susceptible to becoming a vibration source. Thus, according to the pneumatic tire 1, the effect of ensuring a vehicle exterior noise reduction effect can be significantly obtained.

As illustrated in FIGS. 9 to 13, in the pneumatic tire 1 of the present embodiment, the end projections 10B are preferably intermittently disposed in the tire circumferential direction.

According to the pneumatic tire 1, by disposing the end projection 10B intermittently in the tire circumferential direction, the effect of reducing rigidity resistance can be significantly obtained, and the effect of ensuring the vehicle exterior noise reduction effect can be significantly obtained.

Note that the projection portion 10 has a shape that projects from the surface of the tread portion 2 and is susceptible to vulcanization defects when the tire is molded. Thus, the tire mold includes a vent formed at the portion for the projection portion 10. This allows a spew to form on the projection portion 10 side. The end projection 10B of the present embodiment is preferably composed of a spew formed via the vent. To dispose the end projections 10B intermittently in the tire circumferential direction, the end projections 10B can be obtained by being formed as spews. A spew may also be formed at the end of the end projection 10B. Although not illustrated in the drawings, protrusion portions continuously projecting from the end 10Aa of the projection portion body 10A to a position higher than the base end of the end projection 10B may be provided between and separated from the end projections 10B intermittently disposed in the tire circumferential direction.

As illustrated in FIGS. 1 and 2, in the pneumatic tire 1 of the present embodiment, in a meridian cross-section, the projection portion 10 has a distance D in the tire radial direction between the road contact surface S of the tread portion 2 and the end of the end projection 10B is preferably 0.5 mm or greater when the tire is mounted on a regular rim, inflated to the regular internal pressure, and loaded with 70% of the regular load.

When the distance D in the tire radial direction between the road contact surface S of the tread portion 2 and the end of the end projection 10B is less than 0.5 mm, when the pneumatic tire 1 deforms when the vehicle travels, the frequency of the projection portion 10 coming into contact with the road surface and the like is likely to increase, increasing instances of the projection portion 10 deforming. Accordingly, by the distance D in the tire radial direction between the road contact surface S of the tread portion 2 and the end of the end projection 10B being 0.5 mm to greater, the instances of the projection portion 10 deforming are reduced. This allows a vehicle exterior noise reduction effect to be ensured.

As illustrated in FIGS. 3 and 4, in the pneumatic tire 1 of the present embodiment, the projection portion 10 has an angle θ formed by a center straight line SL and a tire radial direction line L in a meridian cross-section preferably ranging from 15° inward in the tire lateral direction to 45° outward in the tire lateral direction when the tire is mounted on a regular rim, inflated to the regular internal pressure, and loaded with 70% of the regular load.

Note that in a meridian cross-section, the center straight line SL is a straight line that joins a center point Pa of the thickness of the end 10Aa of the projection portion body 10A and a center point Pb of the thickness (imaginary profile F) of the base end 10Ab, and run in the projecting direction of the projection portion 10.

The angle θ ranges from −15° to +45°, where the angle θ of the tire radial direction line L is taken as 0° and tilt inward in the tire lateral direction is taken as minus and tilt outward in the tire lateral direction is taken as plus.

When the angle θ formed by the center straight line SL and the tire radial direction line L is less than −15° (larger minus angle), the projection portion 10 is disposed close to the lug groove 24, making a noise shielding effect difficult to obtain. When the angle θ formed by the center straight line SL and the tire radial direction line L is greater than +45° (larger plus angle), the projection portion 10 is susceptible to coming into contact with the tire itself, which may cause wear and chipping in the portion where contact occurs. Accordingly, by the angle θ formed by the center straight line SL and the tire radial direction line L ranging from −15° to +45°, a noise shielding effect from the projection portion 10 can be significantly obtained. Note that to more significantly obtain a noise shielding effect from the projection portion 10, the angle θ formed by the center straight line SL and the tire radial direction line L preferably ranges from −5° to +30°.

Furthermore, the pneumatic tire 1 of the present embodiment preferably has a designated vehicle inner/outer orientation when mounted on a vehicle, and the projection portion 10 is preferably formed at least on the vehicle outer side.

The designated vehicle inner/outer side orientation when the tire is mounted on a vehicle, while not illustrated in the drawings, for example, can be shown via indicators provided on the sidewall portion 4. The side facing the inner side of the vehicle when the tire is mounted on the vehicle is the “vehicle inner side”, and the side facing the outer side of the vehicle is the “vehicle outer side”. Note that the designations of the vehicle inner side and the vehicle outer side are not limited to cases where the tire is mounted on a vehicle. For example, in cases when the tire is mounted on a rim, orientation of the rim with respect to the inner side and the outer side of the vehicle in the tire lateral direction is predetermined. Thus, in cases in which the pneumatic tire 1 is mounted on a rim, the orientation with respect to the vehicle inner side and the vehicle outer side in the tire lateral direction is designated.

According to the pneumatic tire 1, vehicle external noise is released on the vehicle outer side. Thus, by forming the projection portion 10 on at least the vehicle outer side, noise shielding can be effectively provided, and vehicle external noise can be reduced.

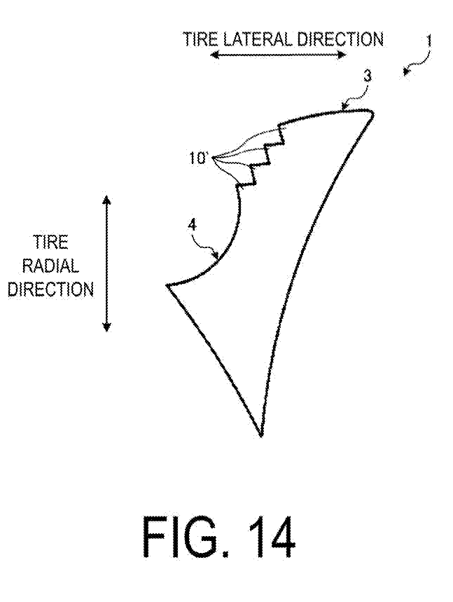

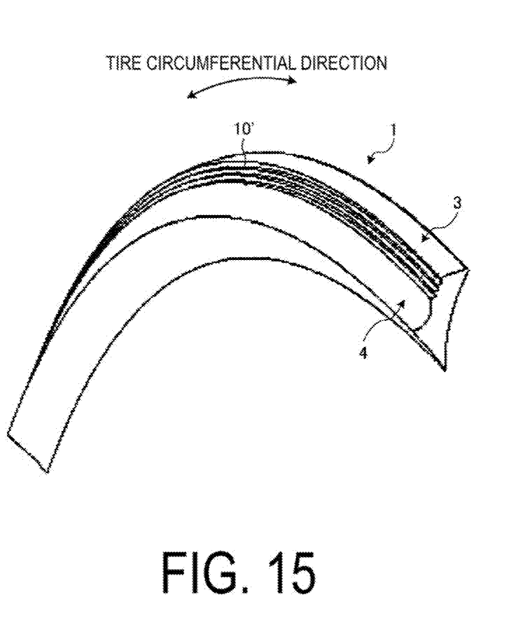

FIG. 14 is an enlarged cross-sectional view of a main portion of another example of the pneumatic tire according to the present embodiment. FIG. 15 is a partial perspective view of the example of the pneumatic tire illustrated in FIG. 14.

As illustrated in FIGS. 14 and 15, another example of the pneumatic tire 1 according to the present embodiment includes a projection portion 10′ instead of the projection portion 10 described above. The projection portion 10′ is provided continuously in the tire circumferential direction and is disposed outward in the tire lateral direction of the opening portion of the outermost lug groove 24 in the tire lateral direction provided on the tread portion 2. The projection portion 10′ is formed projecting outward in the tire radial direction. Additionally, a plurality (four in the present embodiment) of the projection portions 10′ are formed in the tire radial direction. In FIGS. 14 and 15, the projection portions 10′ have a triangular shape in a meridian cross-section with a V-shaped groove provided therebetween.

### EXAMPLES

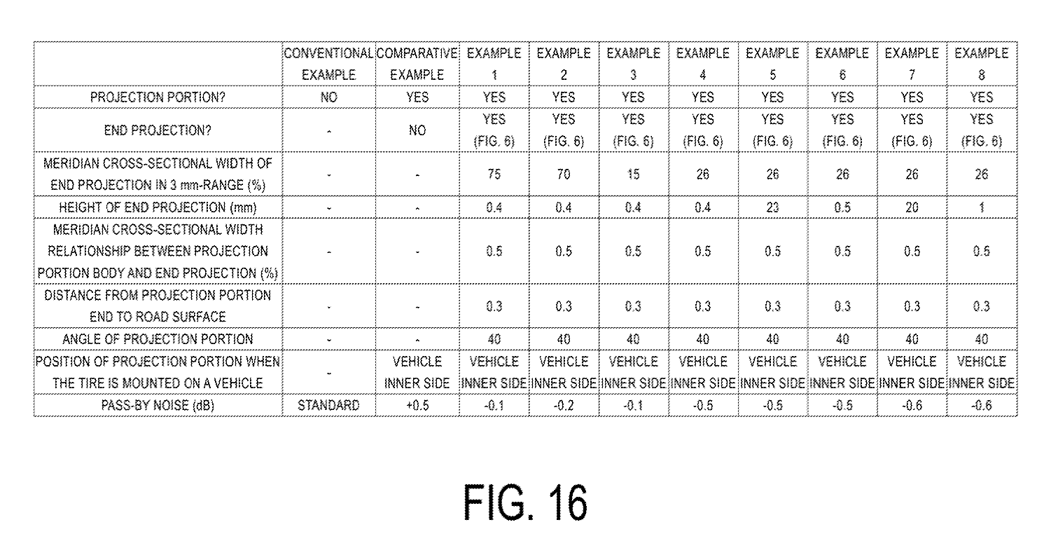

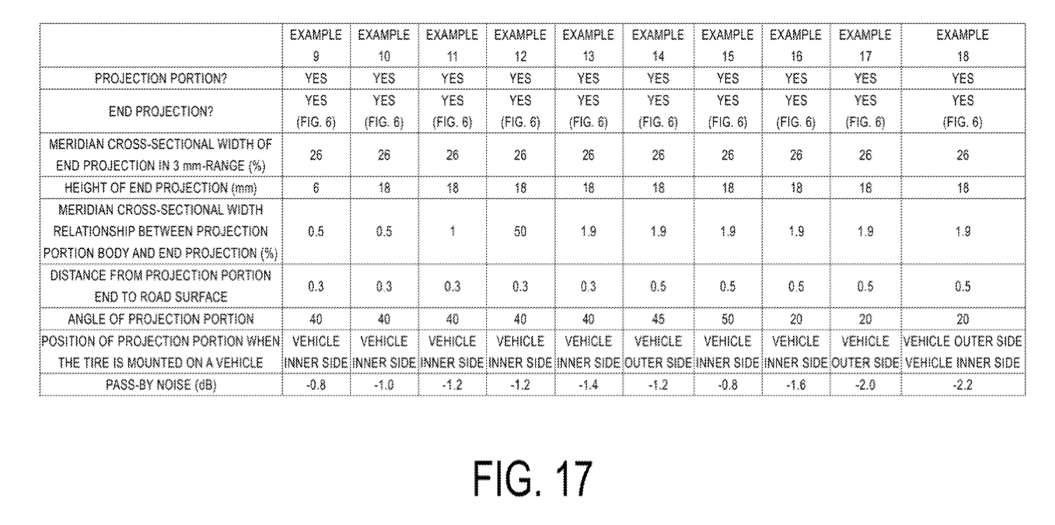

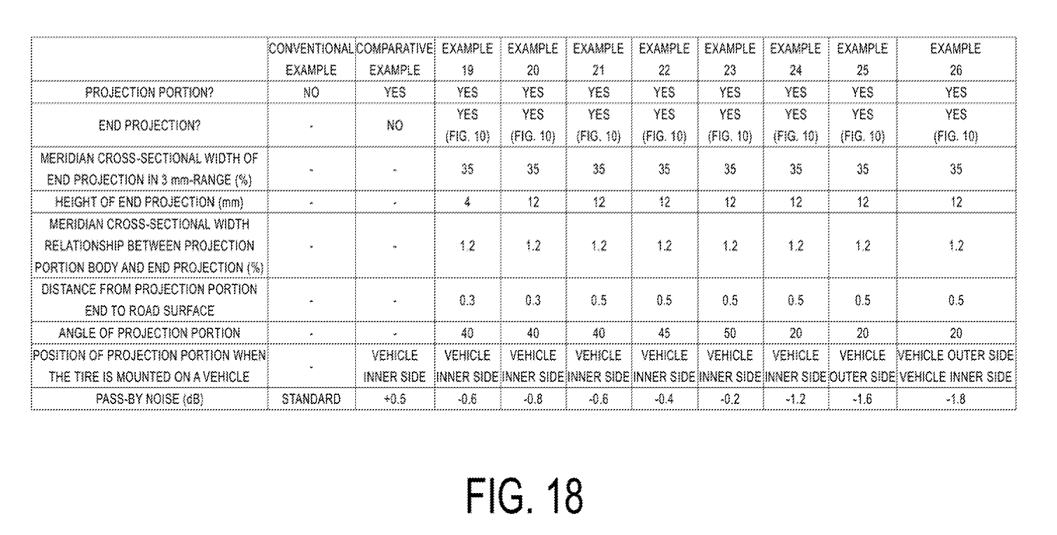

In the examples, performance tests for pass-by noise were performed on a plurality of types of pneumatic tires of different conditions (see FIGS. 16 to 18).

In the performance tests, pneumatic tires (test tires) having a tire size of 245/40R18 93W were mounted on regular rims and inflated to the regular internal pressure (250 kPa). Then, the pneumatic tires were mounted on a sedan type test vehicle having an engine displacement of 3000 cc.

In the evaluation method of pass-by noise, the magnitude of vehicle external pass-by noise was measured according to the tire noise test method specified in ECE (Economic Commission for Europe) Regulation No. 117 Revision 2 (ECE R117-02). In the test, the test vehicle was driven in a section prior to a noise measurement section, and before the noise measurement section the engine was stopped and the test vehicle was allowed to coast in the noise measurement section where the maximum noise level dB (noise level in the frequency range of 800 Hz to 1200 Hz) was measured. This was repeated a plurality of times at a plurality of speeds, the speeds being eight or more substantially evenly divided within the range of ±10 km/h of the standard speed, and the average vehicle external pass-by noise was taken. The maximum noise level dB is the sound pressure dB (A) measured through an A characteristic frequency correction circuit using a microphone installed 7.5 m to the side of a travel center line and 1.2 m up from the road surface at a middle point in the noise measurement section. The measurement results are expressed as index values and evaluated with the conventional example being assigned as the reference (0). In the evaluation, values for the sound pressure dB less than the reference indicate low pass-by noise and superior vehicle external noise reduction performance.

The pneumatic tire of the conventional example illustrated in FIG. 16 includes no projection portions. The pneumatic tire of the comparative example includes a projection portion with the shape illustrated in FIG. 3 but no end projections. As indicated in FIGS. 16 to 18, the pneumatic tires of Examples 1 to 26 are provided with a projection portion with the shape illustrated in FIG. 3, and a projection portion body and an end projection. In Examples 1 to 18, the end projection has the shape continuous in the tire circumferential direction illustrated in FIG. 6. In Examples 19 to 26, the end projection has the shape intermittently disposed in the tire circumferential direction illustrated in FIG. 10. Note that the angle of the projection portion is minus when tilted inward in the tire lateral direction and plus when tilted outward in the tire lateral direction.

As can be seen from the test results of FIGS. 16 to 18, the pneumatic tires of Examples 1 to 26 have low pass-by noise and enhanced vehicle external noise reduction performance.

1. A pneumatic tire, comprising:
a lug groove disposed outermost in a tire lateral direction in a tread portion, the lug groove opening outward in the tire lateral direction; and
a projection portion disposed outward of an opening portion of the lug groove in the tire lateral direction, the projection portion extending outward in a tire radial direction past a groove bottom of the lug groove at maximum groove depth in a meridian cross-section and comprising an end disposed inward of a road contact surface of the tread portion in the tire radial direction, when the pneumatic tire is mounted on a regular rim, inflated to a regular internal pressure, and loaded with 70% of a regular load;
the projection portion comprising a projection portion body projecting from a tire surface, and an end projection extending from the end of the projection portion body with a step portion as an interface, and the end projection having a thinner meridian cross-sectional width than a meridian cross-sectional width of the end of the projection portion body.

2. The pneumatic tire according to claim 1, wherein the end projection, in a 3 mm-range in a projection direction of the projection portion body, has a maximum meridian cross-sectional width 70% or less of a minimum meridian cross-sectional width of the projection portion body.

3. The pneumatic tire according to claim 1, wherein the end projection has an extension height from the projection portion body ranging from 0.5 mm to 20 mm.

4. The pneumatic tire according to claim 1, wherein the end projection has a maximum meridian cross-sectional width from 1% to 50% of a minimum meridian cross-sectional width of the projection portion body.

5. The pneumatic tire according to claim 1, wherein the end projection is disposed intermittently in a tire circumferential direction.

6. The pneumatic tire according to claim 1, wherein the projection portion has a distance in the tire radial direction from the road contact surface of the tread portion to an end of the end projection of 0.5 mm or greater, when the pneumatic tire is mounted on a regular rim, inflated to a regular internal pressure, and loaded with 70% of a regular load.

7. The pneumatic tire according to claim 1, wherein the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

8. The pneumatic tire according to claim 1, wherein a vehicle inner/outer side orientation when the pneumatic tire is mounted on a vehicle is designated, and the projection portion is at least formed on a vehicle outer side.

9. The pneumatic tire according to claim 2, wherein the end projection has an extension height from the projection portion body ranging from 0.5 mm to 20 mm.

10. The pneumatic tire according to claim 9, wherein the end projection has a maximum meridian cross-sectional width from 1% to 50% of a minimum meridian cross-sectional width of the projection portion body.

11. The pneumatic tire according to claim 10, wherein the end projection is disposed intermittently in a tire circumferential direction.

12. The pneumatic tire according to claim 11, wherein the projection portion has a distance in the tire radial direction from the road contact surface of the tread portion to an end of the end projection of 0.5 mm or greater, when the pneumatic tire is mounted on a regular rim, inflated to a regular internal pressure, and loaded with 70% of a regular load.

13. The pneumatic tire according to claim 12, wherein the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

14. The pneumatic tire according to claim 13, wherein a vehicle inner/outer side orientation when the pneumatic tire is mounted on a vehicle is designated, and the projection portion is at least formed on a vehicle outer side.
